(19) United States
(12) Patent Application Publication
(10) Pub. No.: US 2010/0294911 A1
(43) Pub. Date: Nov. 25, 2010

(54) Support Body for Supporting Loads in a Vibration-Damping Fashion, in Particular for Supporting a Coordinate Measuring Machine

(75) Inventors: Klaus Jacobs, Konigsbronn-Ochsenberg (DE); Werner Leitenberger, Heidenheim (DE)

Correspondence Address: LERNER GREENBERG STEMER LLP, P O BOX 2480, HOLLYWOOD, FL, 33022-2480, US

(73) Assignee: CARL ZEISS INDUSTRIELLE MESSTECHNIK GMBH, Oberkochen (DE)

(21) Appl. No.: 12/739,812

(22) PCT Filed: Sep. 26, 2008
(86) PCT No.: PCT/EP08/08361

§ 371 Date: Jun. 24, 2010

(30) Foreign Application Priority Data
Oct. 26, 2007 (DE) 10 2007 052 002.8

(51) Int. Cl. F16M 13/00; B29C 65/02

(52) U.S. Cl. 248/636; 156/245

(57) ABSTRACT

A supporting body for the vibration-damping supporting of loads, in particular for supporting a coordinate measuring machine. The supporting body has a molded part made of expanded foam particles, which are connected to one another, and at least one stabilizing module integrated in the molded part.

The invention relates to a support body for supporting loads in a vibration-damping fashion. The load is, in particular, a coordinate measuring machine. However, the load can also be other objects, for example objects on which, in turn, the coordinate measuring machine is placed. Further examples of equipment are optical microscopes, or microscopes operating with the aid of electromagnetic radiation.

It is known to safeguard vibration-sensitive equipment against the influence of impact excitations by using a heavy baseplate, that is to say one of high mass. Granite plates are therefore much used in coordinate measuring engineering. However, when a strong impact excitation takes place in the vicinity of the arrangement, for example an object falls to the ground, the baseplate can, nevertheless, be set vibrating and the measurement can be disturbed.

It has therefore already been proposed to arrange plastic mats or rubber buffers between the ground and the baseplate. It is also possible to use active vibration-damping systems that, for example, attempt to compensate excited vibrations by means of a countervibration with offset phase.

The active damping systems are associated with high outlay and high costs. Passive damping elements such as, for example, rubber buffers, are admittedly most cost effective than active damping systems, as a rule. However, in the case of corresponding size they are likewise complicated to manipulate and no longer cost effective to produce. Again, rubber materials are in part sensitive to chemicals (such as oils and fats, for example), or even to moisture. A further disadvantage of rubber materials consists in that they are subject to an ageing process that changes their elastic properties. Synthetic plastic materials that contain styrene acrylate or vinyl acetate, for example, require chemical processes in the case of which the conditions for environmental protection are to be complied with to a considerable extent.

It is therefore an object of the present invention to specify a support for loads which acts in a vibration-damping fashion, in particular for the purpose of supporting a coordinate measuring machine, which at least partially avoids the above-mentioned disadvantages. In particular, it is to be possible to produce the support in a simple way, and the support is to be easy to handle and have a low weight. Moreover, the support is to be as insensitive as possible to influences and chemicals, for example moisture, temperature changes and chemicals typically to be found in laboratories such as oils, fat or alcohols.

A support body is proposed for supporting loads in a vibration-damping fashion, in particular for supporting a coordinate measuring machine or another vibration-sensitive unit or a machine. The support body has a molded part made from expanded cellular plastic particles that are interconnected. The support body also has a stabilization module integrated in the molded part.

A basic idea of the present invention also resides in combining a cellular plastic made from expanded cellular plastic particles as composite body with the stabilization module. Stabilization is understood to mean that the cellular plastic body can dissipate forces that otherwise cause it to be more strongly compressed (for example plastically deformed), destroy it and/or upset it. The stabilization module has different mechanical properties to the cellular plastic and stabilizes, in particular, the shape of the cellular plastic body when external forces are acting. However, because the stabilization module is integrated in the molded part, it is protected against external influences such as, for example, moisture and chemicals surrounding the cellular plastic. The integration of the stabilization module in the molded part does not exclude the possibility of parts of the stabilization module projecting out of the cellular plastic, as is the case with a preferred embodiment. In this embodiment, the stabilization module has at least one connecting region that projects from the molded part and to which the stabilization module can be connected with a further stabilizing object. For example, the stabilization module can be connected via the connecting region to a further specimen of the support body, or can be connected to other objects such as, for example, a wall.

A molded part is understood to mean that the cellular plastic body produced from the expanded cellular plastic particles can have a prescribed shape, and forms a unipartite object. The molded part can, as will be explained in more detail, be produced by using a mold that therefore prescribes the external dimensions of the molded part. However, the molded part can also be elaborated in part or entirely from an already existing cellular plastic body, for example by being cut off, cut out, sawed, drilled and/or milled.

Integration of the stabilization module in the molded part is understood to mean that the stabilization module is at least partly surrounded by the cellular plastic (that is to say a part of the module is surrounded). It is preferred for the cellular plastic to enclose within it at least parts of the stabilization module in such a way that a relative movement between the cellular plastic body and the stabilization module is largely excluded in the case of normal loading during the intended use. However, even in this case deformations of the cellular plastic can occur because of the introduction of external forces. By contrast, the stabilization module is preferably configured, and inserted into the molded part, in such a way that it is not deformed upon loading of the support body.

The stabilization module is, in turn, a unipartite body that can, however, optionally consist of a number of components. A preferred example is still to be described. In principle, the stabilization module can consist, for example, of any solid material, or can consist of a number of various solid materials, for example, metal, plastic, composite material (such as, for example, glass fiber reinforced plastic). For example, the stabilization module can be fabricated from various pieces of sheet metal that are interconnected so as to form a dimensionally stable body overall. In particular, the stabilization module can have a cavity with openings on a plurality of sides, in which the cavity is filled up at least partially with cellular plastic particles. It is therefore possible for the interconnected cellular plastic particles both to fill up the interior of the cavity, and to have a stable connection to further cellular plastic particles outside the cavity through the openings. In this case, the stabilization module is particularly firmly integrated in the molded part, a particularly large portion of the molded part being stabilized by the stabilization module.

However, it is also possible, for example, to integrate in the molded part a plurality of stabilization modules that, for example, are individually dimensionally stable per se, and therefore respectively stabilize a region of the molded part.

The molded parts in accordance with the present invention have, in particular, a particulate cellular plastic. A particulate cellular plastic is understood to be a cellular plastic that has particles firmly interconnected. The particles are, in particular, particles already expanded or at least partially expanded before the connection of the particles. Particles are partially expanded when they expand further during the connection of the particles, or thereafter, that is to say they increase their volume.

The material of the cellular plastic particles has, for example, polystyrene, or it consists of polystyrene with additives. However, it is preferred for the material of the cellular plastic particles, preferably of all the cellular plastic particles, to be a polyolefin material. Polyolefin cellular plastics, in particular the particularly preferred polypropylene, are distinguished by a particularly high load-bearing capacity. Here, the fact that the particles are expanded leads to a very low weight of the molded part. Because of the structure of interconnected (in particular, reticularly interconnected) expanded particles, the molded part further has a very high elasticity and flexibility under load. Under load, it is possible both for the individual particles to be deformed, and for remaining cavities between the particles to be reduced. The deformation is largely reversible, depending on the heaviness of the load and the duration of the action of the load. Here, load is understood as an object or a plurality of objects that introduce(s) its/their weight and, as the case may be, further forces into the support body.

Preferred examples of polyolefins are homopolymers and copolymers of ethylene and propylene. Propylene copolymers with a melting point of 125 to 155 degrees Celsius are particularly preferred. Said melting point is the maximum, determined using the DSC (dynamic differential calorimetry) method, at the second melting of the sample (crystalline melting point). The polypropylene copolymers can have, for example, 1 to 30% by weight, in particular 1 to 6% by weight of ethylene and/or such a proportion of C4 to C6 alpha-olefins. Propylene copolymers that have 1 to 6% by weight of ethylene are particularly suitable, since such a proportion by weight constitutes a good compromise between the expandability, the behavior during formation of the molded part (in particular of thermal welding of the particles in the presence of water vapor) and the strength (in particular the compressive load-bearing capacity).

As long as the normal room temperatures are not substantially exceeded, such polyolefins are distinguished, in particular, by a high load-bearing capacity in conjunction with a low specific gravity. They are also resistant to very many chemicals or, as the case may be, may be made resistant by the use of additives (see below). However, they are at least insensitive to moisture, that is to say water vapor.

The cellular plastic is, in particular, a cellular plastic that is obtained by welding cellular plastic particles, the particles having in the expanded state a diameter of, for example, 1 to 8 mm, preferably from 2 to 5 mm. The mean density of the cellular plastic is, for example, in the range of 15 to 100 kg/m³, in particular in the range of 20 to 60 kg/m³, preferably in the range of 30 to 50 kg/m³.

The cellular plastic particles can optionally contain the additives particularly customary for polyolefin cellular plastic particles, or else polystyrene, for example dyes, pigments, fillers, substances for increasing strength, substances for attaining fire resistance, substances that facilitate the separation of the preliminary part from a mold, antistatic substances, stabilizers, materials for attaining static properties, materials for attaining acid resistance, lubricants. These additives are preferably added in quantities such that the desired or above-mentioned effects are attained. Materials for attaining acid resistance are particularly preferred. Their proportion can be, for example, in the range of 0.05 to 0.2 percent by weight of the cellular plastic particle.

The molded part can be, in particular, of approximately cuboid configuration, although individual or a plurality of surfaces can also be curved. It is also preferable for individual surfaces to be structured, that is to say the latter have, for example, projections and/or cutouts.

The molded part preferably has an upper surface for introducing forces of the load to be held, and a lower surface for dissipating the load downward. The load can therefore be mounted on the upper surface directly or via further objects arranged therebetween, such that the load is dissipated downward (for example in a floor) via the lower surface. The cellular plastic body is at least partially deformed under the load. In particular, it is possible thereby to equalize nonuniform loads of the upper surface, that is to say they are dissipated over the lower surface in an approximately uniform fashion. The stabilization module stabilizes the cellular plastic body and prevents breakage of the cellular plastic body and/or upsetting of the support body, for example in the case of extremely nonuniform loading. The refinement, still to be explained below, of a support body arrangement additionally safeguards against upsetting.

The upper surface and/or the lower surface are/is structured in a particular refinement such that they/it have/has a plurality of protruding regions. The protruding regions are formed by the cellular plastic material, that is to say by a plurality of cellular plastic particles, as a rule. These protruding regions preferably have one or more of the following functions. Firstly, nonuniform loads can be equalized particularly well by introducing increased force locally. In the extreme case, for example, only a protruding region is so strongly deformed that it evades the load of the object lying therebelow, for example the floor, lying thereupon, and the action of force from above is again performed uniformly over the surface. The protruding regions can equalize irregularities at the lower surface in a similar way. The protruding regions can, however, also be used as guides for additional objects bearing against the surfaces, for example spacers for equalizing the height differences of various specimens. Owing to the mutual engagement of downwardly projecting regions of a further body into the spaces between the protruding regions of the support body, it is possible to form a common support structure for a load, and therefore to prevent the objects which thus make contact with one another from slipping down on one another.

Alternatively or in addition, the support body can also have an upwardly open cutout. It is therefore also possible to prevent slipping down by inserting into the cutout an element (for example made from plastic-clad metal) that is connected to the load directly or indirectly.

The cutout just mentioned can be part of a cavity arranged in a central region of the molded part. As will be explained in more detail, the cavity is determined by production engineering, for example. During the fabrication of the molded part, it is possible to lay in place of the cavity a hollow body through which gas and/or vapor is fed to the cellular plastic particles.

As already mentioned, the scope of the invention also includes a support body arrangement having a plurality of the support bodies that are defined in this description and in the claims. In the arrangement, at least two of the stabilization modules of different support bodies are interconnected in pairs by at least one connecting object. One of the stabilization modules connected in pairs is connected to the stabilization module of the other support body. Connecting objects made from sheet metal and/or metal tubing, for example, are suitable for the connection. In the case of more than two support bodies of the arrangement (for example for supporting a coordinate measuring machine), it is preferred in each case for the stabilization modules to be connected to the stabilization modules of two other support bodies such that a particularly stable support body arrangement results. An example of such an arrangement with four support bodies is further described in more detail in the description relating to the figures. Consequently, a suitable connection of the stabilization modules avoids upsetting of the support bodies, or else another unintended lateral giving way is therefore avoided.

Also belonging to the scope of the invention is a method for producing a support body for supporting loads in a vibration-damping fashion, in particular the support body in one of the refinements defined in this description and the claims. In the production method, a multiplicity of cellular plastic particles and at least one stabilization module made from another material are inserted into a mold, and a molded part is formed from the cellular plastic particles by interconnecting the cellular plastic particles. The stabilization module is at least partially integrated in the molded part in the process.

In order to form the molded part from the expanded cellular plastic particles, the cellular plastic particles are preferably welded to one another by heating and by introducing water vapor into a mold that contains the cellular plastic particles. In this case, one embodiment of the production method provides that the heating is effected at least partially by introducing hot water vapor. It is therefore possible to dispense entirely or partially with additional heating of the mold or its contents. Instead of this, the heat is fed by the hot water vapor.

However, the invention is not restricted to the feeding of water vapor in order to produce the connection between the cellular plastic particles. For example, it is also possible to apply an adhesive to the surfaces of the cellular plastic particles, for example before insertion in the mold, the adhesive being activated by feeding of a gas that activates the adhesive, that is to say the action of the adhesive is attained. Other methods are also possible. For example, another gas and/or another vapor can be fed into the mold in order to weld the cellular plastic particles to one another.

In a particularly preferred refinement of the production method, a hollow body is arranged in a central region of a cavity that is formed by the mold and holds the cellular plastic particles. The cellular plastic particles are inserted into the cavity, but not into the interior of the hollow body. Water vapor (alternative: another gas and/or another vapor) is then guided through the interior of the hollow body and subsequently through openings in a wall of the hollow body to the cellular plastic particles in order to weld the cellular plastic particles to one another. In other words, the hollow body has, for example, perforations or a multiplicity of small through holes through which the vapor and/or the gas can flow. Moreover, the mold can likewise have a multiplicity of through holes that permit the vapor and/or the gas to exit after said vapor/gas has contributed to connecting the cellular plastic particles.

The gas and/or the vapor are/is fed into the mold under pressure. The required pressure is a function of the inlet cross sections of the openings of the cavity in which the cellular plastic particles are located, of the outlet cross sections of the opening or the openings of the cavity through which the gas and/or the vapor leave(s) the cavity, and of the speed at which the process of connecting the cellular plastic particles is to run.

When hot water vapor is used to interconnect the cellular plastic particles, the water vapor has the effect, in particular, that the cellular plastic particles at the surface go over into another aggregate state by glass transition, in particular an elastomeric aggregate state. The regions of neighboring cellular plastic particles can be interconnected in this other aggregate state. The connection is maintained after cooling below the glass transition temperature. In order to retain the properties of the cellular plastic in the predominant portion of the cellular plastic particles, the glass transition temperature should be exceeded only for a short time and locally. The process can therefore be optimized by simultaneously feeding a suitable gas (for example pentane gas) in order to expand the cellular plastic particles further during the process of connection. The pressure produced by the expansion at the contact points of the individual cellular plastic particles speeds up the production of the connection and increases the reliability of the connection between the cellular plastic particles.

Also within the scope of the invention is a method for supporting a load in a vibration-damping fashion, in particular a coordinate measuring machine. At least one support body is provided, this being, in particular, a support body as defined in this description and/or in the patent claims. The support body has a molded part made from expanded cellular plastic particles that are interconnected. Furthermore, a stabilization module is integrated in the molded part. The load, in particular a measuring table of the coordinate measuring machine, is mounted on the support body. Mounting is also understood in this case to mean that an object such as a spacer disk, for example, is also located between the mounted object and the support body. However, the object can also be mounted directly on the molded part.

The invention enables the object mounted on the support body or bodies to be isolated from external excitation to vibrate. However, vibrations in the support body that pass from the mounted object to the support body are also damped. A high vibration-damping factor is attained because of the cellular plastic material and the integrated stabilization module.

The support body can have further parts, which are connected to it firmly or loosely, for example spacer disks that occupy interspaces between projections on the surface of the cellular plastic body. For example, it is also possible, however, to provide connecting means such as screws and nuts at the connecting regions of the stabilization module, for example in order to fasten a connecting object thereon.

Exemplary embodiments of the invention are now described with reference to the attached drawing. In the individual figures of the drawing:

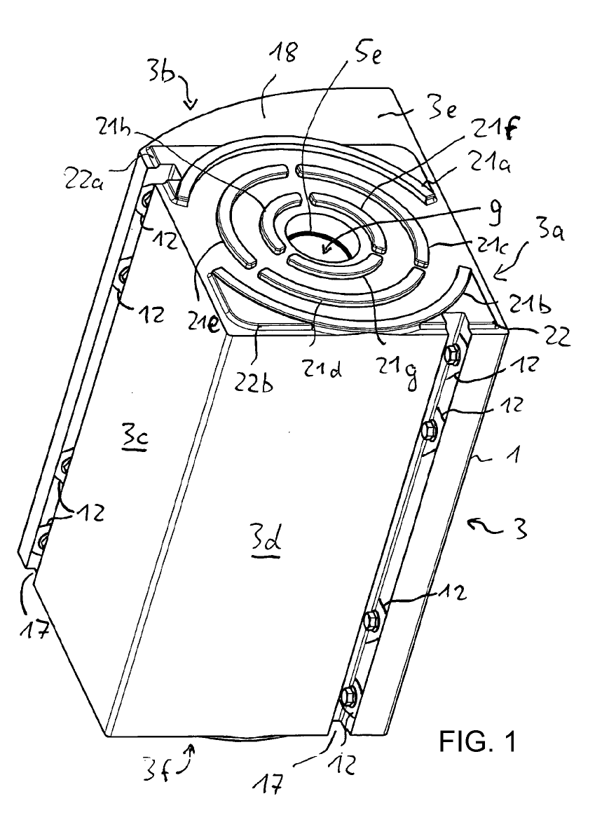

FIG. 1 shows a three-dimensional illustration of a support body,

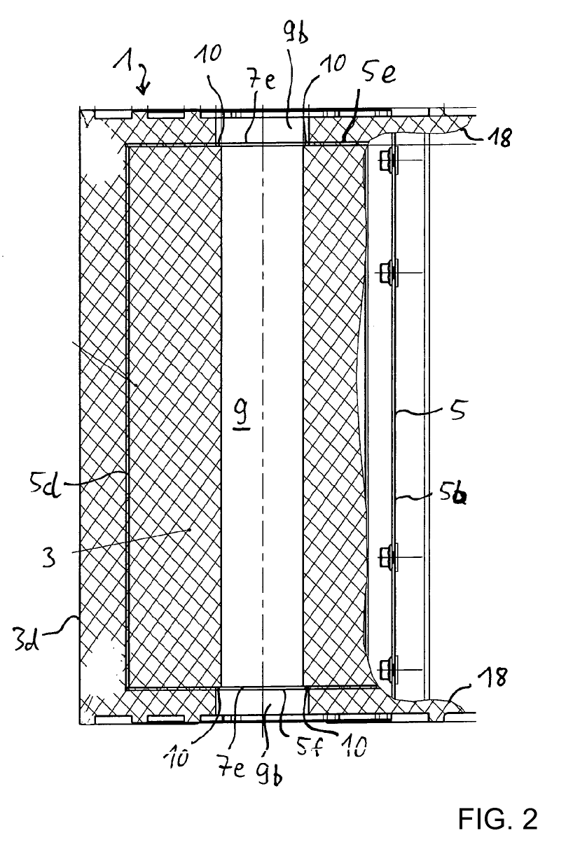

FIG. 2 shows a vertical section through the support body illustrated in FIG. 1, although in this case regions of the cellular plastic body are omitted at the right-hand edge of FIG. 2 in order to illustrate a connecting region of the stabilization module integrated in the molded part,

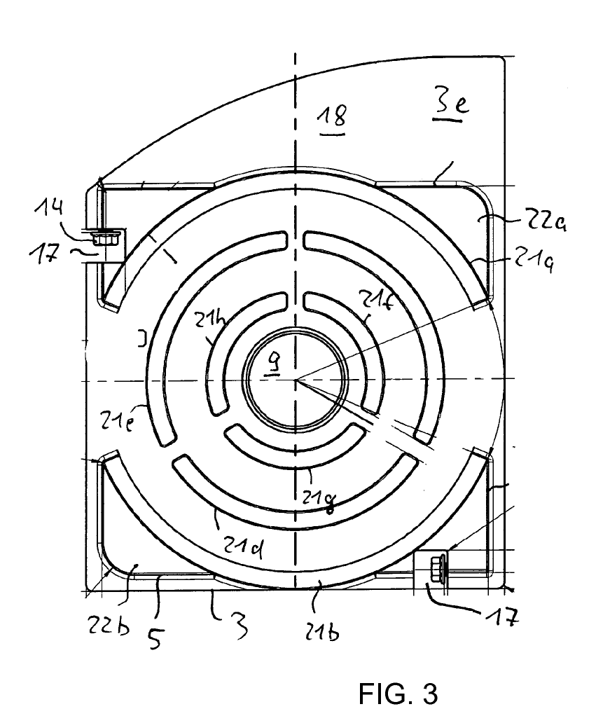

FIG. 3 shows a view from above onto the support body illustrated in FIG. 1 and FIG. 2,

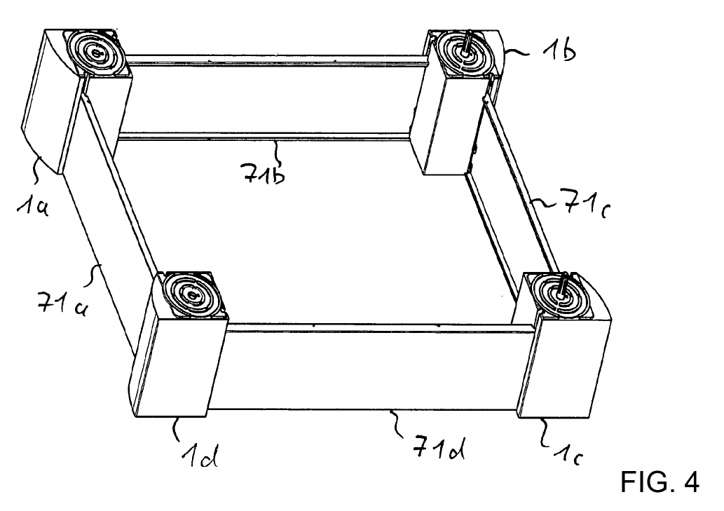

FIG. 4 shows a support body arrangement having four support bodies that are respectively connected to two neighboring support bodies,

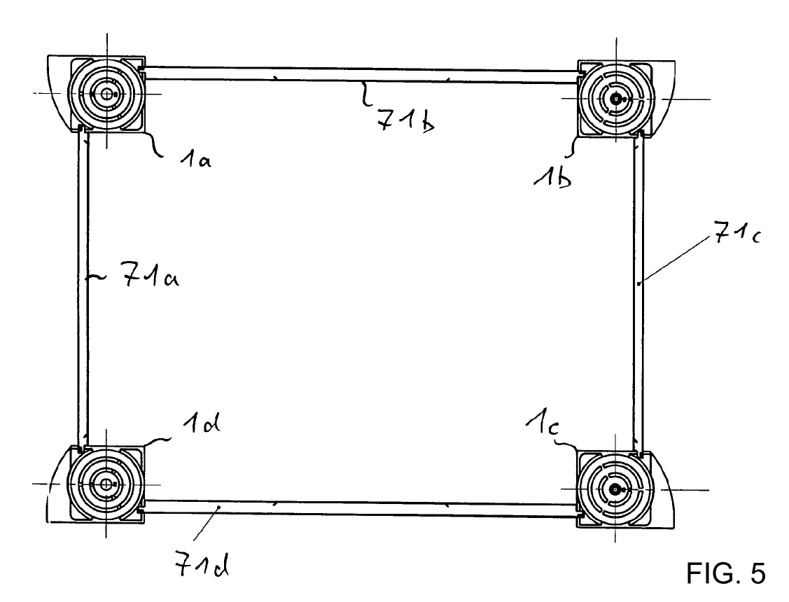

FIG. 5 shows a view from above onto the arrangement in accordance with FIG. 4,

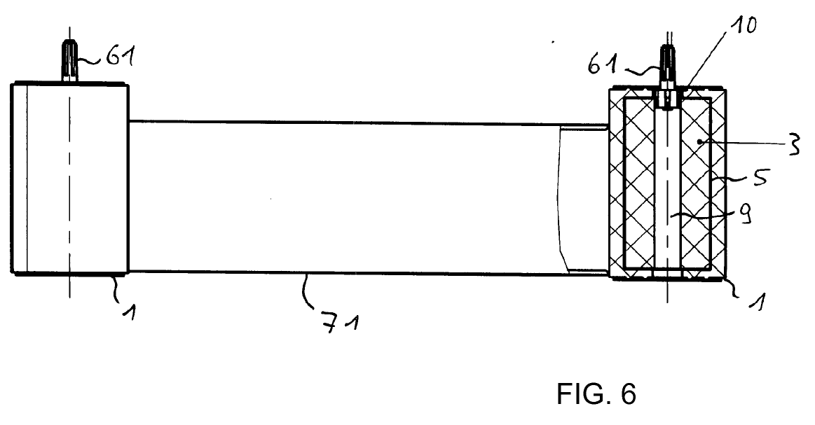

FIG. 6 shows a side view from the right onto the arrangement illustrated in FIG. 4 and FIG. 5, one of the support bodies illustrated therein being shown in a sectional illustration,

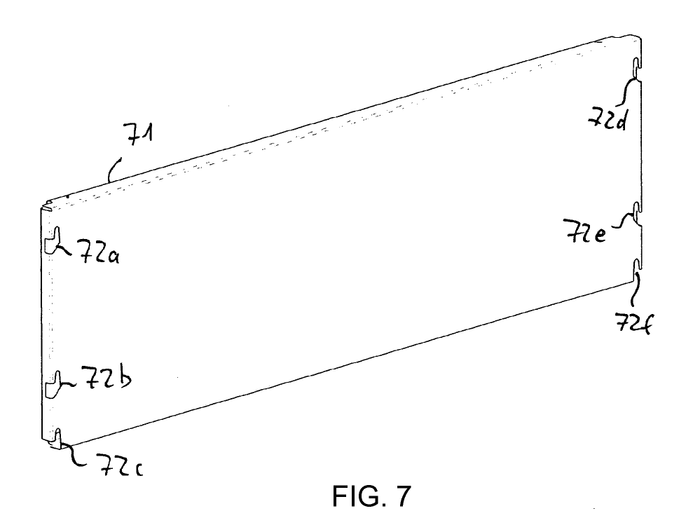

FIG. 7 shows a connecting element of the arrangement illustrated in FIG. 4 to FIG. 6,

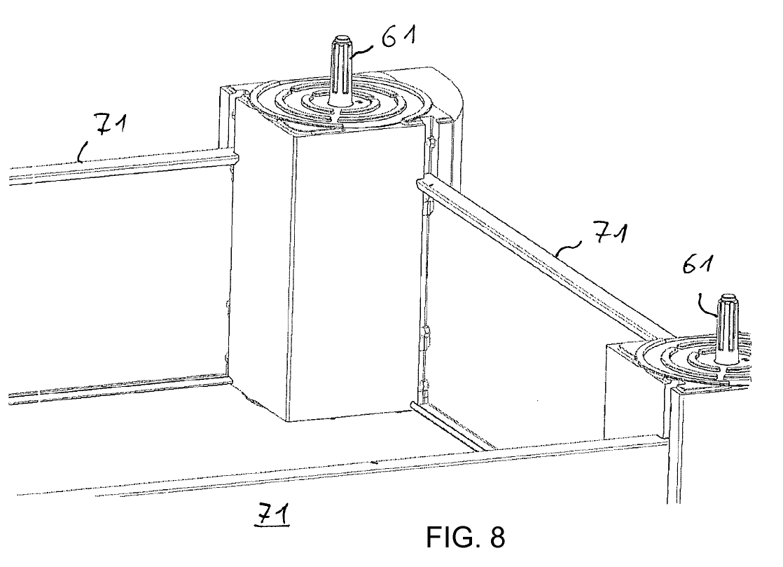

FIG. 8 shows a partial illustration of the arrangement illustrated in FIG. 4 to FIG. 6, from which it is possible to identify the connection of two support bodies via the connecting element illustrated in FIG. 7,

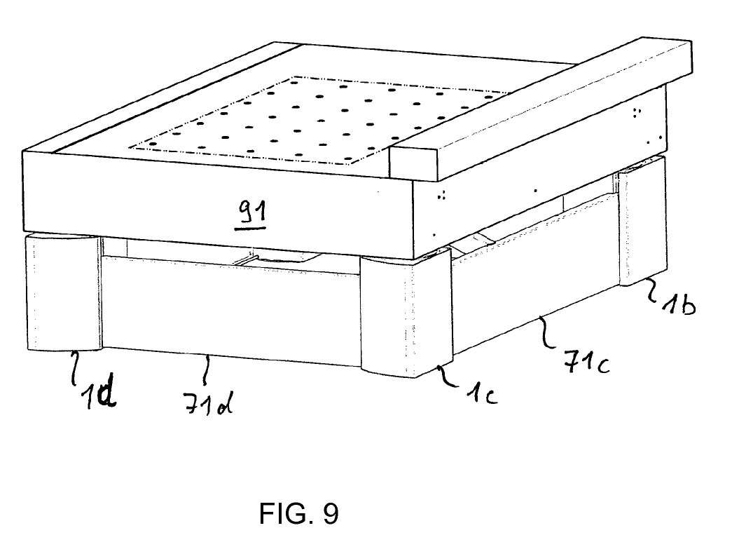

FIG. 9 shows the arrangement in accordance with FIGS. 4 to 6 and 8, a measuring table for a coordinate measuring machine being mounted on the arrangement,

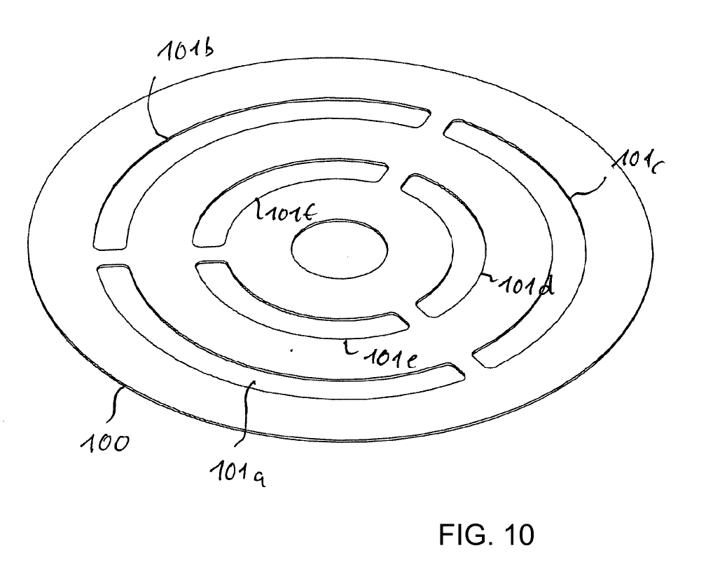

FIG. 10 shows a disk which has cutouts and can be mounted on the support body in accordance with FIG. 1 to FIG. 3,

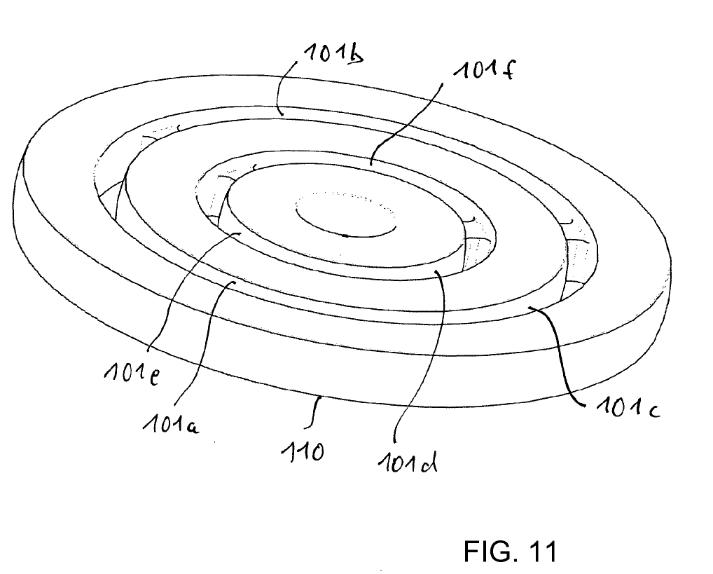

FIG. 11 shows a spacer that can be mounted on a support body in accordance with FIGS. 1 to 3 as an alternative or in addition to the disk illustrated in the figure, in order to bridge or produce a spacing between the support body and a mounted object,

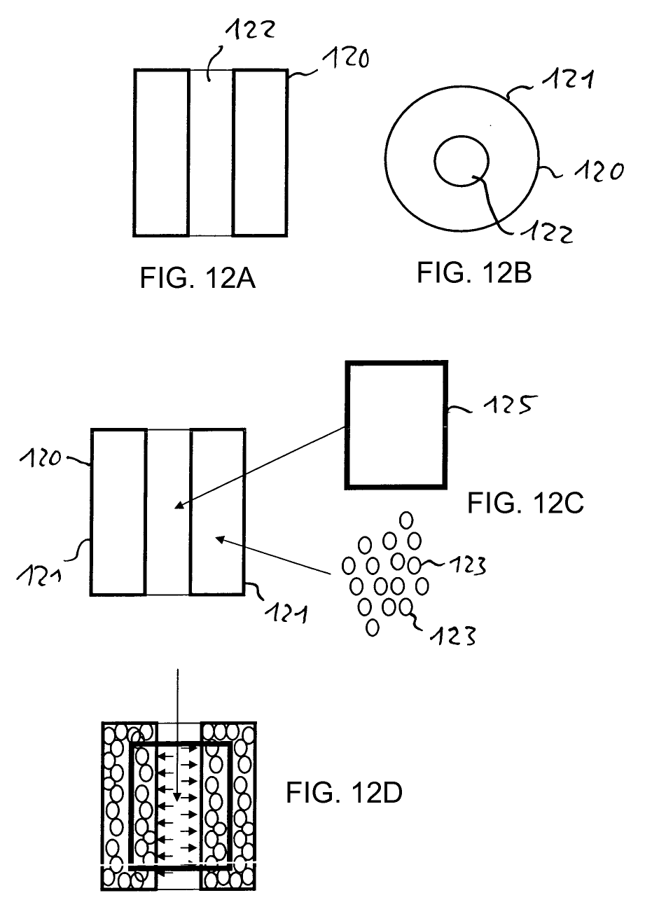

FIGS. 12a-12d show a schematic illustration of a method for producing a support body, and

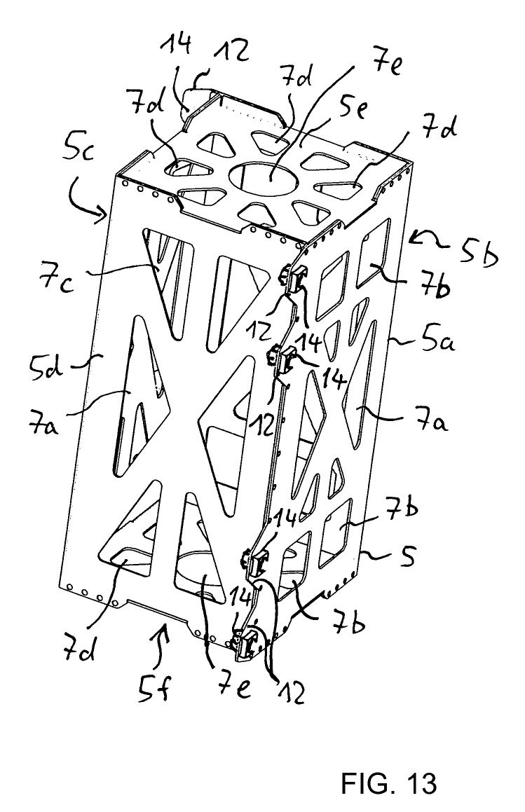

FIG. 13 shows a preferred embodiment of a stabilization module.

FIGS. 1, 2, 3 and 13 show a preferred embodiment of an inventive support body for supporting loads in a vibration-damping fashion. The support body 1 is produced essentially from two different materials. Firstly, it has a cellular plastic body 3 that has preferably been produced from expanded polyolefin cellular plastic particles. A preferred variant of a method for producing the support body 1 is, furthermore, described with the aid of FIG. 12. Moreover, the support body 1 has a stabilization module made from a solid, dimensionally stable material, in particular steel.

The stabilization body 5 is illustrated in three dimensions in FIG. 13. It is seen that the stabilization module 5 is constructed in the manner of a hollow cuboid with 6 outer surfaces running approximately in a plane. Each of the outer surfaces is formed by a surface element 5a-5f that is penetrated by a plurality of openings and runs in a plane. In this case, the surface elements 5a-5f can be formed at least partially by a common piece of material. For example, the surface elements 5a (on the right in FIG. 13) and 5b (at the rear in FIG. 13) may have been produced from a piece of metal with a U-bend of 90°. The same holds for the surface elements 5c (on the left in FIG. 13) and 5d (at the front in FIG. 13). These two pieces of metal are, for example, riveted, soldered and/or welded to one another.

In the particular embodiment illustrated in FIG. 13, the upper surface element 5e and the lower surface element 5f are likewise respectively produced from one piece of metal and can be connected in the same way to the neighboring surface elements 5a-5d, as previously described. As already mentioned, the surface elements 5e and 5f respectively have a plurality of through openings, individual ones of which are denoted in FIG. 13 with the reference numerals 7 and an additional lower case letter, that is to say by 7a-7e. In this case, identical reference numerals denote through openings of the same shape. Most of these through openings 7 have, on the one hand, the function of reducing the weight of the stabilization module 5 and, on the other hand, the function of enabling the cellular plastic body 3 to extend through the through openings 7 such that the material of the cellular plastic body 3 is located both inside and outside the stabilization module 5, and these regions are interconnected (see FIG. 2).

However, this does not hold for the through openings 7e that are arranged centrally in the surface elements 5e and 5f. These through openings 7e are circular in the illustrated embodiment, the center of the circle lying on the point of intersection of the diagonals, which extends rectilinearly from the outer corners of the surface element 5e or 5f to the opposite outer corner. No cellular plastic material is located in the through openings 7e in the finished support body 1 (see FIG. 1 and FIG. 2, for example). Likewise, no cellular plastic material is located overall in a substantially cylindrical cavity 9 of the support body 1, the through openings 7e being located at the bottom and at the top in the cavity 9. However, the through openings 7e of the stabilization module 5 are not located right at the top or right at the bottom in the cavity 9. Rather, the cylindrical region of the cavity 9, which extends between the through openings 7e, expands toward the ends of the cavity 9 to a larger cylindrical diameter. A shoulder 10 is therefore formed at the through openings 7e, respectively at the top and at the bottom in the cavity 9.

With the aid of this shoulder 10, it is possible to insert into the cavity 9 from outside an object whose external dimensions correspond approximately to the inside diameter of the expanded cylindrical region that is located at the ends of the cavity 9. It is possible in this case to dimension the through opening 7e such that it has a smaller inside diameter than the end regions 9b such that an object (or region of an object) inserted into the end of the cavity 9 and having corresponding external dimensions strikes the material of the surface element 5e or 5f of the stabilization module 5 and cannot be inserted further (deeper) into the cavity 9. It is therefore also possible to introduce forces into the stabilization body 5 at the ends of the cavity 9. However, as long as no such inserted object is located both at one and at the other end of the cavity 9, these introduced forces are not guided through the support body 1 directly via the stabilization module 5, but are, however, also dissipated via the cellular plastic material of the cellular plastic body 3. Consequently, it is also ensured in this case that the introduced load is acted upon in a vibration-damping fashion and/or is vibrationally decoupled from the base.

An object that can, for example, be inserted into the upper end of the cavity 9 is to be seen from the arrangement in FIG. 6 now to be examined in more detail. The object is denoted by the reference numeral 61 and consists, for example, of metal that is clad with plastic. It is also to be seen that although the object is supported on the shoulder 10, that is to say on the stabilization module 5, a narrower part of the object 61 penetrates deeper into the cavity 9 than the shoulder 10.

Returning to FIG. 13 and the illustration of the stabilization module 5, there are seen extensions 12 that are formed on the surface elements 5a and 5b and extend beyond the outer surface of the cuboid in a continuation of the flat courses of the surface elements 5a, 5b. Located on the edge, illustrated at the front in FIG. 13, of the surface element 5a and on the edge of the surface element 5b illustrated at the back on the left in FIG. 13, are in each case four of the extensions 12 that are distributed over the extent of the edge. Arranged on each of the extensions are fastening means 14 that have a screw and a nut in the exemplary embodiment, the screw extending through a through bore formed in the extension 12. Objects can therefore be fastened on the extensions 12. More details will be given on the objects, in particular a connecting metal sheet 71 as illustrated in FIG. 7.

The extensions 12 are located in the embodiment of the support body 1, which is well in evidence in FIG. 1 and FIG. 3, in recesses 17 of the cellular plastic body 3, the recesses being located over the entire height in a rectilinear direction on various outer surfaces of the cellular plastic body 3, in the exemplary embodiment on the outer surfaces 3c and 3d, which run approximately in a plane. The reference numerals 3a-3f of the outer surfaces of the cellular plastic body 3 are selected such that they denote outer surfaces that run approximately parallel to the surface elements of the stabilization module 5 with the same lower case letters. For example, the approximately flat outer surface 3a of the cellular plastic body 3 runs parallel to the surface element 5a of the stabilization module 5.

Because of the recesses 17 at the outer surfaces 3c, 3d, the extensions 12 are accessible for the fastening of external objects that extend inward into the recess 17 in a fashion approximately perpendicular to the recessed surface.

When the terms above, at the bottom, on the right and on the left are used in this description of the figures, this relates to the illustration in the figures. However, by way of example it is also possible for the support body 1 to be rotated by comparison with the illustration in FIG. 3 and for the side lying on the top in FIG. 1 therefore to be located at the bottom.

In the case of the preferred refinement of the support body, the support body is configured symmetrically in relation to a horizontal plane at half the height such that it can be used in the same way even given the opposite orientation. This is particularly useful because it is possible in this way to make use of identical support bodies in order to produce the arrangement illustrated in FIG. 4 and FIG. 5, for example.

The external shape of the cellular plastic body 3 is now explained in more detail below. It is to be noted that in the illustration in FIG. 2 a part of the cellular plastic body 3 is illustrated in a recessed fashion in the right-hand part of the figure so as to be able to illustrate the connecting means of the stabilization module 5 in profile at the outer surface 3c of the cellular plastic body 3. The shape of the outer surfaces of the cellular plastic body 3, specifically the outer surfaces 3c, 3d, has already been previously described. Overall, the cellular plastic body 3 has a substantially cuboid external shape, although one of the outer surfaces of flat configuration in a cuboid is configured as a curved outer surface 3b which means that one outer surface, specifically the outer surface 3a, is of longer configuration than the opposite outer surface 3c running in parallel. An additional stability can be achieved in this way for the overall arrangement which is illustrated in FIG. 4 and FIG. 5. Moreover, an additional shock damper against impacts that are exerted laterally from outside against the region 18 is formed by the outer region 18, running along the curved outer surface 3b, of the cellular plastic body 3.

The upper surface 3e and the lower surface 3f are preferably fashioned as already mentioned in the exemplary embodiment and also otherwise preferably in the same way. They have two regions 22a, 22b that are raised by comparison with the flat base level of the upper surface 3e, and moreover further raised regions 21a-21h are provided that extend upward starting from the base level. These regions 21 are shaped in the manner of annular segments and arranged running around the center formed by the central opening of the cavity 9. In this case, three inner annular segments 21f, 21g, 21h form an inner circle around the central opening of the cavity 9. An interspace is respectively present in this case between the neighboring annular segments 21f, 21g, 21h. Three further annular segments 21c, 21d, 21e form a middle annulus around the opening of the cavity 9, there being present in each case, in turn, between the neighboring annular segments 21c, 21d, 21e a spacing that is aligned in a radial direction in a rectilinear fashion with respect to the spacings between the inner annular segments. Two outer annular segments 21a, 21b are also provided. These annular segments also have the same radius in relation to one another and are centered on the center of the central opening of the cavity 9. The two annular segments 21a, 21b have larger spacings from one another which are not aligned radially with the spacings of the middle and inner annular segments.

This configuration of the surface renders it possible for a component such as is illustrated in FIG. 10, or another component, for example as is illustrated in FIG. 11, to be mounted on the base level of the surface 3e such that the component 100 or 110 also rests on the base level of the surface 3e between the annular segments 21. The components 100 or 110 therefore have recesses 101a-101f shaped and arranged in accordance with the middle and inner annular segments. The difference between the components 100 and 110 consists only in that the component 110 is of greater thickness and therefore rises higher up above the base level of the surface 3e when it is mounted. Moreover, in the case of the component 110, the recesses 101, which extend around the center of the annular recesses at the same radius in relation to one another, can be continuously interconnected at the upper end of the component 110, since the component 110 is higher than the annular segments 21. It is also possible to mount the component 100 on the surface 3e, since the component 100 is not as high as the annular segments 21, and to additionally lay the component 110 on the component 100.

In accordance with this principle, further components can be provided in the manner of the components 100 and 110 such that it is possible to undertake to equalize spacings and/or equalize heights or dimensional differences of various support bodies in relation to an object lying thereabove, for example a granite plate. The height equalization takes place, for example, in the manner of suitably dimensioned shims. Here, the embodiments shown in the figures are not shims of conventional type, but the components illustrated by way of example in FIG. 10 and FIG. 11.

However, it is also possible to mount directly on the surface 3e or on, for example, the component 100 in accordance with FIG. 10 a projecting part that is shaped in the manner of the component 110 and belongs to the load to be mounted, or is connected thereto.

With regard to the shape of the cellular plastic body, the configuration of the stabilization module, the overall arrangement of the stabilization module and cellular plastic body, and with regard to other features, the embodiment shown in the figures is purely exemplary. The features named in the description of the figures and referred to in this exemplary embodiment can also be present individually or in any desired combination for other embodiments of the support body.

For example, a differently configured support body can also be fashioned symmetrically in relation to a horizontal reflection plane lying at half height, or in another way such that it can be loaded at opposite outer surfaces optionally at the top or at the bottom (that is to say can also be turned over), the fastening regions, accessible from outside, of the stabilization module can be fashioned otherwise or be accessible from outside at other regions of the support body, more than one outwardly open cavity can be present in the support body (in particular in the case of substantially larger support bodies) (in order to guide gases and or vapors through the cellular plastic during production), and/or the projecting regions on the top side or underside of the cellular plastic body can be omitted or fashioned otherwise.

An arrangement for supporting loads in a vibration-damping fashion emerges with the aid of FIGS. 4 to 8. FIG. 9 shows a load on such an arrangement.

It may be seen from the three-dimensional illustration of FIG. 4 and from the view from above in accordance with FIG. 5 that the arrangement has four support bodies 1a-1d that are arranged at positions that correspond to the corners of a rectangle. These support bodies 1 are respectively connected in pairs to the support bodies neighboring them via a connecting object, specifically here the connecting metal sheet 71 illustrated in FIG. 7. The metal sheet 71 is provided in this case in different lengths in the arrangement. Consequently, the spacing, for example between the support body 1a and the support body 1d, on the one hand, and the support body 1a and the support body 1b, on the other hand, differs in accordance with the length of the connecting metal sheets 71a, 71b.

The support bodies 1a to 1d are identically configured. However, the support bodies 1a and 1c, on the one hand, and the support bodies 1b and 1d, on the other hand, are oppositely oriented, that is to say the two support bodies would need to be turned over in the event of replacement of the support bodies 1a, 1b, before they could again be connected to the connecting metal sheets 71 at the positions provided. At their opposite ends, the connecting metal sheets 71 have recesses 72a-72f for connecting the connecting metal sheets 71 to the support bodies 1. At the recesses 72, the connecting metal sheets are suspended on the suspending means, particularly the screws, in three of the connecting regions lying one above another in each case. The screws can subsequently be tightened so that the connection is ensured.

The support bodies 1a to 1d are, in particular, configured exactly as has already been explained with the aid of FIGS. 1 to 3.

As already briefly described, FIG. 6 shows an object 61 for each of the support bodies 1, the object 61 being inserted into the open end, at the top, of the cavity 9. In order to illustrate this more effectively, the support body 1 illustrated on the right in FIG. 6 is illustrated in a cutaway fashion in the case of the view in accordance with FIG. 6 onto the arrangement illustrated in FIGS. 4 and 5. Just like the section in accordance with FIG. 2, the section of the right-hand support body in FIG. 6 is a vertical section through the middle of the cavity such that the cavity can be identified in longitudinal section in the middle from top to bottom.

All four support bodies 1a to 1d of the arrangement in accordance with FIG. 5 and FIG. 6, in particular, are equipped with the objects 61 that are inserted into the cavity from above. A partial perspective illustration with the objects 61 inserted is shown in FIG. 8. In turn, FIG. 9 shows that a measuring table for a coordinate measuring machine is mounted on the arrangement of the support bodies and connecting surface. Here, the objects 61 (not illustrated) engage in cutouts at the bottom on the measuring table 91. The measuring table is produced, in particular, from granite.

A method is now explained for producing the support body, for example, the support body illustrated in FIG. 1 and FIG. 2.

FIG. 12a shows in schematic fashion a sectional illustration with a vertical section through a mold 120. A view from above onto the mold 120 is illustrated in FIG. 12b. The mold 120 is shaped as a hollow cylinder, that is to say a cylindrical recess 122 is located in the middle of the mold 120 in a fashion coaxial with the outer cylinder walls 121. As is not illustrated in more detail in FIG. 12a and FIG. 12b, both the walls of the cylindrical recess 122, and the outer walls 121, have a multiplicity of small through openings that, for example, have a circular cross section and have an outside diameter of 0.2 to 0.7 mm. These through openings enable gases or vapors to pass through, as is yet to be described in more detail.

In the next step, the stabilization module 125, which can be the stabilization module 5 in accordance with FIG. 13, for example, is firstly inserted into the mold 120. This is achieved, for example, by virtue of the fact that the mold 120 can be parted at half height. As a result the stabilization module 125 is then located inside the mold 120, as can also be seen from FIG. 12d. In this case, the wall elements, running in a vertical direction, of the stabilization module 125 extend in the region of the mold outside the cylindrical recess 122, that is to say between the cylindrical inner wall, which encloses the cylindrical cutout 122, and the outer wall 121. Subsequently, a multiplicity of partially expanded polyolefin particles, in particular polypropylene particles with, possibly, additives and/or an admixture of polyethylene are filled into the hollow cylindrical region of the mold 120, for example through a filling opening (not illustrated in more detail) of the mold 120. The result is illustrated schematically in FIG. 12d. However, the hollow cylindrical region of the mold 120 is preferably filled approximately completely with the cellular plastic particles 123.

Subsequently, hot water vapor at a temperature of approximately 150° C. under a pressure of 2 bar is fed, just as illustrated schematically in FIG. 12, through the internal cylindrical cavity 122 and the through openings in the walls of the mold 120 into the space that contains the partially expanded cellular plastic particles. In this process, a gas (for example pentane gas) is preferably added to the water vapor such that the cellular plastic particles are further expanded while they are exposed to the hot water vapor. Consequently, the surfaces of mutually adjoining particles fuse under the pressure of the further expansion. This results in a reliable and quickly effected connection of the cellular plastic particles to the neighboring particles. This process of further expansion is, however, not mandatory for the invention. It is also possible to use already completely expanded particles that are simply further connected to one another when they are located in the mold.

Subsequently, particularly after the support body and the mold have been cooled, the mold is, for example, parted again, and the finished support body can then be removed from the mold.

Caking of the cellular plastic particles on the surface of the mold is prevented, for example, by suitable selection of the material of the mold (for example aluminum). Alternatively or in addition, the mold can be provided with a silicone-free release agent before the filling with the cellular plastic particles.

1-20. (canceled)

21. A support body for supporting loads in a vibration-damping fashion, the support body comprising:
a molded part made from expanded cellular plastic particles that are connected to one another; and
at least one stabilization module integrated in the molded part.

22. The support body according to claim 21 configured for supporting a coordinate measuring machine.

23. The support body according to claim 21, wherein said stabilization module has at least one connecting region projecting from said molded part and enabling a connection of said stabilization module to a further stabilizing object.

24. The support body according to claim 21, wherein said stabilization module is formed of metal.

25. The support body according to claim 21, wherein said stabilization module has a cavity formed therein with openings on a plurality of sides, and wherein said cavity is filled up at least partially with cellular plastic particles.

26. The support body according to claim 25, wherein at least a portion of said cellular plastic particles are polyolefin particles.

27. The support body according to claim 26, wherein said polyolefin particles fabricated from one or more of homopolymers and copolymers of ethylene and/or propylene.

28. The support body according to claim 21, wherein said molded part has an upper surface for introducing forces of the load, and a lower surface for dissipating the forces of the load downwardly.

29. The support body according to claim 28, wherein said molded part has a plurality of protruding regions on at least one of said upper surface and said lower surface.

30. The support body according to claim 29, wherein material configured to introduce forces of the load into said molded part is inserted between said protruding regions.

31. The support body according to claim 21, comprising an element inserted into an upwardly open cutout in the support body and projecting upwardly from said cutout.

32. The support body according to claim 21, wherein a central region of said molded part is formed with a cavity that is open on at least one side.

33. A support body assembly, comprising:
a plurality of support bodies according to claim 21;
at least one connecting object interconnecting at least two of said stabilization modules of mutually different said support bodies in pairs.

34. The support body assembly according to claim 33, wherein said connecting object is made from at least one of sheet metal and metal tubing.

35. A method of producing a support body for supporting a load in a vibration-damping fashion, the method which comprises:
inserting a multiplicity of cellular plastic particles and at least one stabilization module into a mold; and
forming a molded part from the cellular plastic particles by interconnecting the cellular plastic particles.

36. The method according to claim 35, which comprises forming the support body according to claim 21.

37. The method according to claim 35, which comprises welding the cellular plastic particles to one another by heating and by introducing water vapor into the mold.

38. The method according to claim 37, which comprises heating, at least partially, by introducing hot water vapor.

39. The method according to claim 35, which comprises arranging a hollow body in a central region of a cavity, formed by the mold, for holding the cellular plastic particles, inserting the cellular plastic particles into the cavity, but not into an interior of the hollow body, and guiding water vapor through the interior of the hollow body and subsequently through openings in a wall of the hollow body to the cellular plastic particles in order to weld the cellular plastic particles to one another.

40. The method according to claim 35, wherein at least a portion of the cellular plastic particles are polyolefin particles.

41. The method according to claim 40, wherein the polyolefin particles are fabricated from homopolymers and/or copolymers of ethylene and/or propylene.

42. A method for supporting a load in a vibration-damping fashion, the method which comprises:
providing at least one support body with a molded part made from expanded cellular plastic particles that are interconnected to one another and at least one stabilization module integrated in the molded part; and
mounting the load on the support body.

43. The method according to claim 42, which comprises mounting a measuring table of a coordinate measuring machine for supporting the coordinate measuring machine in a vibration-damping fashion.

44. The method according to claim 42, which comprises mounting the load on a bearing surface formed by the cellular plastic particles.

45. The method according to claim 42, wherein at least a portion of the cellular plastic particles are polyolefin particles.

46. The method according to claim 45, wherein the polyolefin particles are fabricated from homopolymers and/or copolymers of ethylene and/or propylene.
